(19) United States
(12) Patent Application Publication
(10) Pub. No.: US 2025/0041802 A1
(43) Pub. Date: Feb. 6, 2025

(54) CONTROLLER AND METHOD FOR CONFIGURING PUMP AND DOSER OF AFTERTREATMENT SYSTEM

(71) Applicant: Cummins Emission Solutions Inc., Columbus, IN (US)

(72) Inventors: Kerang Wang, Columbus, IN (US); Li Liu, Allentown, PA (US)

(73) Assignee: Cummins Emission Solutions Inc., Columbus, IN (US)

(21) Appl. No.: 18/716,197

(22) PCT Filed: Nov. 8, 2022
(86) PCT No.: PCT/US2022/049280

§ 371 Date: Jun. 4, 2024

Related U.S. Application Data
(60) Provisional application No. 63/286,231, filed on Dec. 6, 2021.

(51) Int. Cl. B01D 53/94; F01N 3/20

(52) U.S. Cl. CPC B01D 53/9495; B01D 53/9418; F01N 3/208; B01D 2251/2067; B01D 2257/404; B01D 2258/012; F01N 2610/02; F01N 2610/144; F01N 2610/146; F01N 2900/1808

(57) ABSTRACT

A controller for use in an aftertreatment system that includes a doser configured to dose reductant into a decomposition chamber and a pump configured to supply the reductant to the doser is configured to be operatively coupled to the doser and the pump and programmed to cause the pump and the doser to operate in an idle mode in which the pump supplies the reductant from a reductant tank to the doser at steady state, the doser does not dose the reductant, and the reductant supplied to the doser by the pump is recirculated to the reductant tank. The controller is also programmed to, while the pump and the doser operate in the idle mode, determine a first speed of the pump required to achieve a predetermined target pressure. The controller is also programmed to cause the pump and the doser to operate in a dosing mode.

### CROSS-REFERENCE TO RELATED APPLICATION

The present application is a National Phase based on PCT Application No. PCT/US2022/049280, filed Nov. 8, 2023, which claims priority to and the benefit of U.S. Provisional Application No. 63/286,231, filed Dec. 6, 2021. The entire disclosure of these applications is hereby incorporated by reference herein.

### TECHNICAL FIELD

The present application relates generally to systems and methods for improving an aftertreatment system based on different pump speeds obtained in different modes.

### BACKGROUND

For internal combustion engines, such as diesel engines, nitrogen oxide (NOₓ) compounds may be emitted in exhaust. It may be desirable to reduce NOₓ emissions to, for example, comply with environmental regulations. To reduce NOₓ emissions, a reductant may be dosed into the exhaust by a doser. The reductant facilitates conversion of a portion of the exhaust into non-NOₓ emissions, such as nitrogen (N₂), carbon dioxide (CO₂), and water (H₂O), thereby reducing NOₓ emissions.

An aftertreatment system may include a pump, a doser, and a controller to dose or provide the reductant to a decomposition chamber. The doser may include a pressure sensor that generates a pressure value indicating pressure of the doser. Based on the pressure measurement value, the controller can control the amount of dosing by adjusting the pump, the doser or both. For example, based on the pressure measurement value, the controller may determine whether the doser is over-dosing or under-dosing, and configure the pump, the doser, or both to compensate for the over-dosing or under-dosing.

### SUMMARY

While an existing approach of controlling or adjusting the doser based on pressure sensor measurements may correct errors due to variations in pumps, the existing approach may not fully account for errors due to variations in dosers.

According to one embodiment of the present disclosure, a controller is provided for use in an aftertreatment system that includes a doser configured to dose reductant into a decomposition chamber and a pump configured to supply the reductant to the doser. The controller is configured to be operatively coupled to the doser and the pump. The controller is programmed to: cause the pump and the doser to operate in an idle mode in which the pump supplies the reductant from a reductant tank to the doser at steady state, the doser does not dose the reductant, and the reductant supplied to the doser by the pump is recirculated to the reductant tank; while the pump and the doser operate in the idle mode, determine a first speed of the pump required to achieve a predetermined target pressure; cause the pump and the doser to operate in a dosing mode in which the pump supplies the reductant to the doser, and the doser doses the reductant into the decomposition chamber at steady state; while the pump and the doser operate in the dosing mode, determine a second speed of the pump required to achieve the predetermined target pressure; and generate a command to configure the pump and the doser, based on the first speed and the second speed.

In one aspect, the doser includes a pressure sensor configured to provide a pressure measurement value that has been adjusted by an offset pressure value. The controller is programmed to determine the offset pressure value, based on the first speed and the second speed, and generate the command based on the determined offset pressure value.

In one aspect, the controller is programmed to determine an effective orifice area of the doser, based on the determined offset pressure value, and generate the command to configure the pump and the doser, based on the determined effective orifice area.

In one aspect, the controller is programmed to determine a displacement amount of the pump, based on the determined offset pressure value, and generate the command to configure the pump and the doser, based on the determined displacement amount.

In one aspect, the controller is programmed to update a pump flow model of the aftertreatment system, based on the determined displacement amount and the determined effective orifice area, and generate the command to configure the pump and the doser, based on the updated pump flow model.

In one aspect, the controller is programmed to determine a duty cycle of the doser, based on the effective orifice area, and generate the command to configure the pump and the doser, based on the determined duty cycle of the doser.

In one aspect, the controller is programmed to determine an effective orifice area of the doser, based on the first speed and the second speed, determine a duty cycle of the doser, based on the effective orifice area, and generate the command to configure the pump and the doser, based on the determined duty cycle of the doser.

According to another embodiment, a controller is provided for use in an aftertreatment system that includes a first doser configured to dose reductant into a first decomposition chamber, a second doser configured to dose the reductant into a second decomposition chamber, and a pump configured to supply the reductant to the first doser, the first doser coupled between the pump and the second doser. The controller is configured to be operatively coupled to the first doser, the second doser, and the pump. The controller is programmed to cause the pump, the first doser and the second doser to operate in an idle mode in which the pump supplies the reductant from a reductant tank to the first doser at steady state, the first doser and the second doser do not dose the reductant, and the reductant supplied to the first doser and the second doser by the pump is recirculated to the reductant tank; while the pump, the first doser and the second doser operate in the idle mode, determine a first speed of the pump required to achieve a predetermined target pressure; cause the pump, the first doser and the second doser to operate in a first dosing mode in which the pump supplies the reductant to the first doser, the first doser doses the reductant into the first decomposition chamber at steady state, and the second doser does not dose the reductant; while the pump, the first doser, and the second doser operate in the first dosing mode, determine a second speed of the pump required to achieve the predetermined target pressure; cause the pump, the first doser and the second doser to operate in a second dosing mode in which the pump supplies the reductant to the first doser, the second doser doses the reductant into the second decomposition chamber at steady state, and the first doser does not dose the reductant; while the pump, the first doser, and the second doser operate in the second dosing mode, determine a third speed of the pump required to achieve the predetermined target pressure; and generate a command to configure the pump, the first doser and the second doser, based on the first speed, the second speed, and the third speed.

In one aspect, the pump is configured to supply the reductant to the second doser through the first doser.

In one aspect, the second doser includes a pressure sensor configured to provide a pressure measurement value that has been adjusted by an offset pressure value. The controller is programmed to determine the offset pressure value, based on the first speed and the third speed, and generate the command to configure the pump, the first doser and the second doser, based on the determined offset pressure value.

In one aspect, the controller is programmed to determine a first effective orifice area of the second doser, based on the determined offset pressure value, and generate the command to configure the pump, the first doser and the second doser, based on the determined first effective orifice area.

In one aspect, the controller is programmed to determine a displacement amount of the pump, based on the determined offset pressure value, and generate the command to configure the pump, the first doser and the second doser, based on the determined displacement amount.

In one aspect, the controller is programmed to determine a second effective orifice area of the first doser, based on the determined displacement amount of the pump, the first speed, and the second speed, and generate the command to configure the pump, the first doser and the second doser, based on the determined second effective orifice area.

In one aspect, the controller is configured to update a pump flow model of the aftertreatment system, based on the determined displacement amount, the determined first effective orifice area, and the determined second effective orifice area, and generate the command to configure the pump, the first doser and the second doser, based on the updated pump flow model.

In one aspect, the controller is programmed to determine a dosing adjustment factor of the first doser, based on the first effective orifice area and the second effective orifice area, and generate the command to configure the first doser, according to the dosing adjustment factor.

In one aspect, the controller is programmed to determine a displacement amount of the pump, based on the first speed, determine a first effective orifice area, based on the displacement amount of the pump, the first speed, and the second speed, determine a second effective orifice area, based on the displacement amount of the pump, the first speed, and the third speed, determine a first dosing adjustment factor of the first doser, based on the first effective orifice area, determine a second dosing adjustment factor of the second doser, based on the second effective orifice area, and generate the command to configure the first doser and the second doser, according to the first dosing adjustment factor and the second dosing adjustment factor.

According to another embodiment, a method is provided for use in an aftertreatment system that includes a doser configured to dose reductant into a decomposition chamber and a pump configured to supply the reductant to the doser. The method includes causing, by a processor, the pump and the doser to operate in an idle mode in which the pump supplies the reductant from a reductant tank to the doser at steady state, the doser does not dose the reductant, and the reductant supplied to the doser by the pump is recirculated to the reductant tank; determining, by the processor, a first speed of the pump required to achieve a predetermined target pressure, while the pump and the doser operate in the idle mode; causing, by the processor, the pump and the doser to operate in a dosing mode in which the pump supplies the reductant to the doser, and the doser doses the reductant into the decomposition chamber at steady state; determining, by the processor, a second speed of the pump required to achieve the predetermined target pressure, while the pump and the doser operate in the dosing mode; and generating, by the processor, a command to configure the pump and the doser, based on the first speed and the second speed.

In one aspect, the doser includes a pressure sensor configured to provide a pressure measurement value that has been adjusted by an offset pressure value. The method includes determining, by the processor, the offset pressure value, based on the first speed and the second speed; and generating, by the processor, the command based on the determined offset pressure value.

In one aspect, the method includes determining, by the processor, an effective orifice area of the doser, based on the determined offset pressure value; and determining, by the processor, a displacement amount of the pump, based on the determined offset pressure value.

In one aspect, the method includes updating, by the processor, a pump flow model of the aftertreatment system, based on the determined displacement amount and the determined effective orifice area; and generating, by the processor, the command to configure the pump and the doser, based on the updated pump flow model.

In one aspect, the method includes determining, by the processor, a duty cycle of the doser, based on the effective orifice area; and generating the command to configure the pump and the doser, based on the determined duty cycle of the doser.

In one aspect, the method includes determining, by the processor, an effective orifice area of the doser, based on the first speed and the second speed, determining, by the processor, a duty cycle of the doser, based on the effective orifice area; and generating, by the processor, the command to configure the pump and the doser, based on the determined duty cycle of the doser.

According to another embodiment, a method is provided for use in an aftertreatment system that includes a first doser configured to dose reductant into a first decomposition chamber, a second doser configured to dose the reductant into a second decomposition chamber, and a pump configured to supply the reductant to the first doser, the first doser coupled between the pump and the second doser. The method includes causing, by a processor, the first doser and the second doser to operate in an idle mode in which the pump supplies the reductant from a reductant tank to the first doser at steady state, the first doser and the second doser do not dose the reductant, and the reductant supplied to the first doser and the second doser by the pump is recirculated to the reductant tank; determining, by the processor, a first speed of the pump required to achieve a predetermined target pressure, while the pump, the first doser and the second doser operate in the idle mode; causing, by the processor, the pump, the first doser and the second doser to operate in a first dosing mode in which the pump supplies the reductant to the first doser, the first doser doses the reductant into the first decomposition chamber at steady state, and the second doser does not dose the reductant; determining, by the processor, a second speed of the pump required to achieve the predetermined target pressure, while the pump, the first doser, and the second doser operate in the first dosing mode; causing, by the processor, the pump, the first doser and the second doser to operate in a second dosing mode in which the pump supplies the reductant to the first doser, the second doser doses the reductant into the second decomposition chamber at steady state, and the first doser does not dose the reductant; determining, by the processor, a third speed of the pump required to achieve the predetermined target pressure, while the pump, the first doser, and the second doser operate in the second dosing mode; and generating, by the processor, a command to configure the pump, the first doser and the second doser, based on the first speed, the second speed, and the third speed.

In one aspect, the second doser includes a pressure sensor configured to provide a pressure measurement value that has been adjusted by an offset pressure value. The method includes determining, by the processor, the offset pressure value, based on the first speed and the third speed; and generating, by the processor, the command to configure the pump, the first doser and the second doser, based on the determined offset pressure value.

In one aspect, the method includes determining, by the processor, a first effective orifice area of the second doser, based on the determined offset pressure value, determining, by the processor, a displacement amount of the pump, based on the determined offset pressure value; and determining, by the processor, a second effective orifice area of the first doser, based on the determined displacement amount of the pump, the first speed, and the second speed.

In one aspect, the method includes updating, by the processor, a pump flow model of the aftertreatment system, based on the determined displacement amount, the determined first effective orifice area, and the determined second effective orifice area; and generating, by the processor, the command to configure the pump, the first doser and the second doser, based on the updated pump flow model.

In one aspect, the method includes determining, by the processor, a dosing adjustment factor of the first doser, based on the first effective orifice area and the second effective orifice area; and generating, by the processor, the command to configure the first doser, according to the dosing adjustment factor.

In one aspect, the method includes determining, by the processor, a displacement amount of the pump, based on the first speed; determining, by the processor, a first effective orifice area, based on the displacement amount of the pump, the first speed, and the second speed; determining, by the processor, a second effective orifice area, based on the displacement amount of the pump, the first speed, and the third speed; determining, by the processor, a first dosing adjustment factor of the first doser, based on the first effective orifice area; determining, by the processor, a second dosing adjustment factor of the second doser, based on the second effective orifice area; generating, by the processor, the command to configure the first doser and the second doser, according to the first dosing adjustment factor and the second dosing adjustment factor.

### BRIEF DESCRIPTION OF THE DRAWINGS

Details of various embodiments are set forth in the accompanying drawings and the description below. Other features, aspects, and advantages of the disclosure will become apparent from the description, the drawings, and the claims, in which:

FIG. 1 is a block schematic diagram of an example aftertreatment system having a doser;

FIG. 2 is a block schematic diagram of an example aftertreatment system;

FIG. 3 is a flow chart showing an example process of operating the aftertreatment system based on different pump speeds obtained in different modes;

FIG. 4 is a flow chart showing an example process of operating the aftertreatment system based on different pump speeds obtained in different modes;

FIG. 5 is a block schematic diagram of an example aftertreatment system having two dosers;

FIG. 6 is a block schematic diagram of an example aftertreatment system;

FIG. 7 is a flow chart showing an example process of operating the aftertreatment system based on different pump speeds obtained in different modes; and

FIG. 8 is a flow chart showing an example process of operating the aftertreatment system based on different pump speeds obtained in different modes.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

### I. Overview

Following below are more detailed descriptions of various concepts related to, and implementations of, methods, apparatuses, and for implementing corrections to a reductant delivery system in an aftertreatment system of an internal combustion engine. The various concepts introduced above and discussed in greater detail below may be implemented in any of numerous ways, as the described concepts are not limited to any particular manner of implementation. Examples of specific implementations and applications are provided primarily for illustrative purposes.

Disclosed herein are related to systems and methods for improving an aftertreatment system that includes a pump, a doser, and a controller to dose or provide the reductant to a decomposition chamber. In one aspect, the different pump speeds are obtained in different modes: an idle mode and a dosing mode. In the idle mode, the pump supplies the reductant from a reductant tank to the doser at steady state, the doser does not dose the reductant, and the reductant supplied to the doser by the pump is recirculated to the reductant tank. In the dosing mode, the pump supplies the reductant to the doser, and the doser doses the reductant into the decomposition chamber at steady state. In one aspect, a first speed of the pump required to achieve a target pressure can be determined, while the pump and the doser operate in the idle mode. In addition, a second speed of the pump required to achieve the target pressure can be determined, while the pump and the doser operate in the dosing mode. Based on the first speed and the second speed obtained in different modes, a command to configure the pump and the doser can be generated.

In one aspect, controlling the aftertreatment system based on the pressure sensor measurement of the doser may correct errors due to variations in pumps. For example, the pump and the doser can be configured to achieve the target pressure value. Then, a pressure measurement value of the doser operating according to such configuration can be obtained. Based on the difference between the target pressure value and the pressure measurement value, whether the doser is over-dosing or under-dosing can be determined. Moreover, the pump and the doser can be configured to compensate for the over-dosing or under-dosing. While controlling the aftertreatment system based on the pressure sensor measurements alone may correct errors due to pump-to-pump variations, it may be insufficient to correct errors due to variations in dosers or variations due to installation.

Controlling the aftertreatment system based on the pressure sensor measurements alone may become more difficult, when the pressure sensor of the doser is trimmed or adjusted. In some cases, the pressure sensor is trimmed or adjusted to correct errors or variations in the pressure sensor. Often, the pressure measurement value output by the pressure sensor is internally adjusted or trimmed by a manufacture of the doser, and the amount of adjustment to the pressure sensor may be unknown. Without knowing the amount of adjustment, estimating other parameters (e.g., effective injector orifice area or displacement amount) of the doser may be difficult, and cause inaccuracy in controlling the aftertreatment system.

In one aspect, the disclosed systems and methods may obtain pump speeds in different modes, and determine the offset pressure value, the effective injector orifice area, the displacement amount, or any combination of them based on the pump speeds obtained in different modes. Based on the determined values, the controller may control the aftertreatment system with improved accuracy.

### II. Overview of Aftertreatment System Including Single Doser

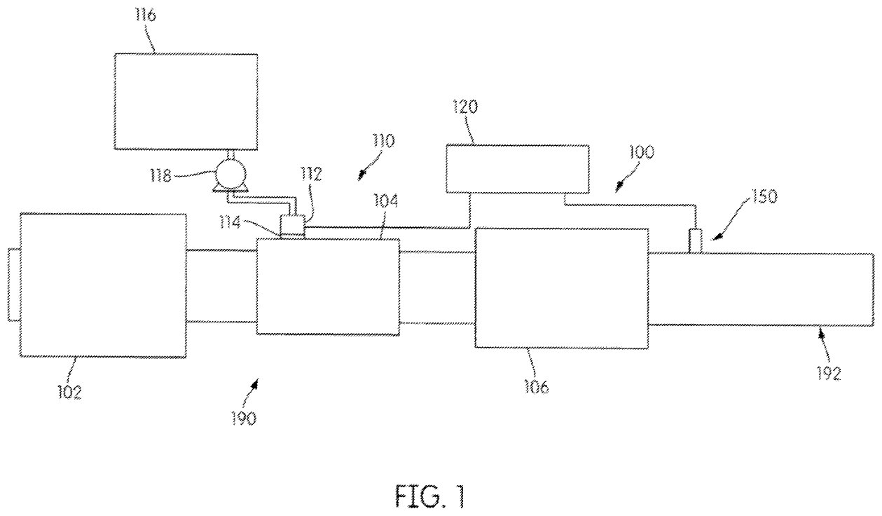

FIG. 1 depicts an aftertreatment system 100 having an example reductant delivery system 110 for an exhaust system 190. The aftertreatment system 100 includes a particulate filter, for example a diesel particulate filter (DPF) 102, the reductant delivery system 110, a decomposition chamber 104 (e.g., reactor, reactor pipe, etc.), a SCR catalyst 106, and a sensor 150.

The DPF 102 is configured to remove particulate matter, such as soot, from exhaust gas flowing in the exhaust system 190. The DPF 102 includes an inlet, where the exhaust gas is received, and an outlet, where the exhaust gas exits after having particulate matter substantially filtered from the exhaust gas and/or converting the particulate matter into carbon dioxide. In some implementations, the DPF 102 may be omitted.

The decomposition chamber 104 is configured to convert a reductant, such as urea or diesel exhaust fluid (DEF), into ammonia. The decomposition chamber 104 includes a reductant delivery system 110 having a doser 112 configured to dose the reductant into the decomposition chamber 104 (for example, via an injector such as the injector described below). In some implementations, the reductant is injected upstream of the SCR catalyst 106. The reductant droplets then undergo the processes of evaporation, thermolysis, and hydrolysis to form gaseous ammonia within the exhaust system 190. The decomposition chamber 104 includes an inlet in fluid communication with the DPF 102 to receive the exhaust gas containing NOₓ emissions and an outlet for the exhaust gas, NOₓ emissions, ammonia, and/or reductant to flow to the SCR catalyst 106.

The decomposition chamber 104 includes or is coupled to the doser 112 such that the doser 112 may dose the reductant into the exhaust gases flowing in the exhaust system 190. The doser 112 may include an insulator 114 interposed between a portion of the doser 112 and the portion of the decomposition chamber 104 on which the doser 112 is mounted. The doser 112 is fluidly coupled to a reductant tank 116. The reductant tank 116 may include multiple reductant tanks 116. In some implementations, a pump 118 may be used to pressurize the reductant from the reductant tank 116 for delivery to the doser 112. In some embodiments, the pump 118 is pressure controlled (e.g., controlled to obtain a target pressure, etc.). The reductant tank 116 may be, for example, a diesel exhaust fluid tank containing Adblue®.

The doser 112 and pump 118 are also electrically or communicatively coupled to a controller 120. The controller 120 is configured to control the doser 112 to dose reductant into the decomposition chamber 104. The controller 120 may also be configured to control the pump 118. The controller 120 may include a microprocessor, an application-specific integrated circuit (ASIC), a field-programmable gate array (FPGA), etc., or combinations thereof. The controller 120 may include memory, which may include, but is not limited to, electronic, optical, magnetic, or any other storage or transmission device capable of providing a processor, ASIC, FPGA, etc. with program instructions. The memory may include a memory chip, Electrically Erasable Programmable Read-Only Memory (EEPROM), Erasable Programmable Read Only Memory (EPROM), flash memory, or any other suitable memory from which the controller 120 can read instructions. The instructions may include code from any suitable programming language.

The SCR catalyst 106 is configured to assist in the reduction of NOₓ emissions by accelerating a NOₓ reduction process between the ammonia and the NOₓ of the exhaust gas into diatomic nitrogen, water, and/or carbon dioxide. The selective catalytic reduction (SCR) catalyst 106 includes an inlet in fluid communication with the decomposition chamber 104 from which exhaust gas and reductant are received and an outlet in fluid communication with an end of the exhaust system 190.

The exhaust system 190 may further include an oxidation catalyst (for example, a diesel oxidation catalyst (DOC)) 192 in fluid communication with the exhaust system 190 (e.g., downstream of the SCR catalyst 106 or upstream of the DPF 102) to oxidize hydrocarbons and carbon monoxide in the exhaust gas.

In some implementations, the DPF 102 may be positioned downstream of the decomposition chamber 104. For instance, the DPF 102 and the SCR catalyst 106 may be combined into a single unit. In some implementations, the doser 112 may instead be positioned downstream of a turbocharger or upstream of a turbocharger.

The sensor 150 may be coupled to the exhaust system 190 to detect a condition of the exhaust gas flowing through the exhaust system 190. In some implementations, the sensor 150 may have a portion disposed within the exhaust system 190; for example, a tip of the sensor 150 may extend into a portion of the exhaust system 190. In other implementations, the sensor 150 may receive exhaust gas through another conduit, such as one or more sample pipes extending from the exhaust system 190. While the sensor 150 is depicted as positioned downstream of the SCR catalyst 106, it should be understood that the sensor 150 may be positioned at any other position of the exhaust system 190, including upstream of the DPF 102, within the DPF 102, between the DPF 102 and the decomposition chamber 104, within the decomposition chamber 104, between the decomposition chamber 104 and the SCR catalyst 106, within the SCR catalyst 106, or downstream of the SCR catalyst 106. In addition, two or more sensors 150 may be utilized for detecting a condition of the exhaust gas, such as two, three, four, five, or six sensors 150 with each sensor 150 located at one of the aforementioned positions of the exhaust system 190.

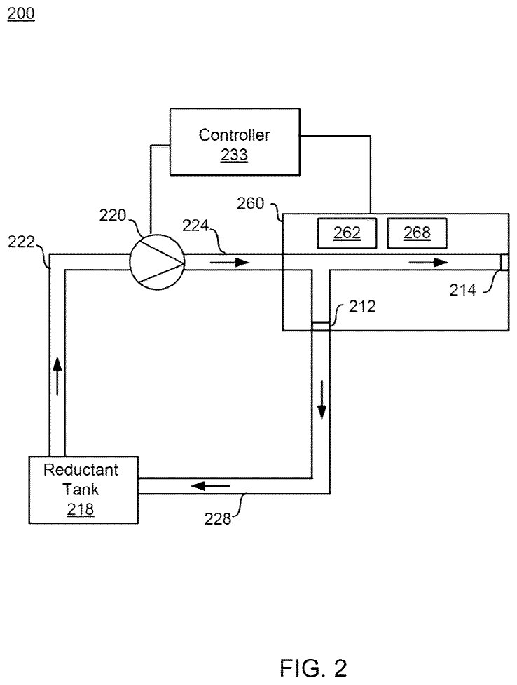

FIG. 2 depicts an aftertreatment system 200 for reducing NOₓ emissions. The aftertreatment system 200 includes a reductant tank 218, a pump 220, a doser 260, and a controller 233. In this embodiment, the reductant tank 218 corresponds to the reductant tank 116, the pump 220 corresponds to the pump 118, the doser 260 corresponds to the doser 112, and the controller 233 corresponds to the controller 120. These components may operate together to dose or provide reductant and generate materials (e.g., ammonia) to reduce NOₓ emissions. In some embodiments, the aftertreatment system 200 includes more, fewer, or different components than shown in FIG. 2. For example, the aftertreatment system 200 may include the decomposition chamber 104 coupled to the doser 260.

In one configuration, the reductant tank 218 is fluidly coupled to the pump 220 through a pipeline 222, and the pump 220 is fluidly coupled to the doser 260 through a pipeline 224. In one configuration, the doser 260 is fluidly coupled to the reductant tank 218 through a pipeline 228, and fluidly coupled to the decomposition chamber 104. In one configuration, the controller 233 is communicatively coupled to the pump 220 and the doser 260 through a wired medium (e.g., conductive trace or wire) or a wireless medium (e.g., wireless link such as Wi-Fi, cellular, Bluetooth, etc.). In this configuration, the controller 233 may generate electrical signals or commands to operate the pump 220, the doser 260, or both to dose reductant into the decomposition chamber 104.

In some embodiments, the reductant tank 218 is a component that stores reductant. The reductant may be, for example, urea, diesel exhaust fluid (DEF), Adblue®, a urea water solution (UWS), an aqueous urea solution (e.g., AUS32, etc.), and other similar fluids. The reductant tank 218 may include multiple reductant tanks 218. In one configuration, the reductant tank 218 includes an inlet fluidly coupled to a first outlet of the doser 260 through the pipeline 228, and an outlet fluidly coupled to an inlet of the pump 220 through the pipeline 222. In this configuration, the reductant tank 218 may provide the reductant to the pump 220, and receive recirculated reductant from the doser 260.

The pump 220 is a component that pressurizes the reductant from the reductant tank 218 for delivery to the doser 260. In some embodiments, the pump 220 is pressure controlled (e.g., controlled to obtain a target pressure, etc.). In one configuration, the pump 220 includes an inlet fluidly coupled to the outlet of the reductant tank 218, and an outlet fluidly coupled to the inlet of the doser 260. In addition, the pump 220 is communicatively coupled to the controller 233 to receive an electrical signal or a command indicating a pump speed or displacement amount of the reductant. In this configuration, the pump 220 may provide the reductant from the reductant tank 218 to the doser 260, according to the pump speed or the displacement amount indicated by the electrical signal or the command.

The doser 260 is a component that provides or doses the reductant from the pump 220 into the decomposition chamber 104. The doser 260 may be directly mounted on the decomposition chamber 104. In one configuration, the doser 260 includes an inlet fluidly coupled to the outlet of the pump 220, a first outlet fluidly coupled to the inlet of the reductant tank 218, a second outlet directly coupled to an inlet of the decomposition chamber 104, and internal pipelines connected between the inlet and the outlets. The doser 260 includes an injector 214 disposed at the second outlet of the doser 260, through which some of the reductant from the inlet can be dosed or provided to the decomposition chamber 104. The doser 260 also includes a return orifice 212 of the first outlet of the doser 260, through which remaining reductant not provided to the decomposition chamber 208 can be recirculated back to the reductant tank 218. The doser 260 may include a pressure sensor 268 that detects pressure within the doser 260 (e.g., pressure within the internal pipelines) and generates an electrical signal corresponding to the pressure measurement value. The doser 260 may also include an interface circuit 262 communicatively coupled to the controller 233 and internal devices such as pressure sensor 268 and the injector 214. In this configuration, the interface circuit 262 may receive an electrical signal or command from the controller 233, and configure opening or closing of the injector 214 according to the electrical signal or command. By adjusting amounts of opening or a duty cycle of opening and closing of the injector 214, a desired amount of reductant can be provided to the decomposition chamber 104. In addition, the interface circuit 262 may receive the electrical signal corresponding to the pressure measurement value from the pressure sensor 268, and generate sensor measurement data indicating the pressure measurement value according to the electrical signal. The interface circuit 262 may transmit the sensor measurement data to the controller 233.

The controller 233 is a component that generates electrical signals or commands to operate the pump 220 and the doser 260 to dose reductant into the decomposition chamber 104. In some embodiments, the controller 233 includes a processor and a memory. The processor may be embodied as a microprocessor, an application-specific integrated circuit (ASIC), a field-programmable gate array (FPGA), or any combination thereof. The memory may be embodied as a memory chip, Electrically Erasable Programmable Read-Only Memory (EEPROM), Erasable Programmable Read Only Memory (EPROM), flash memory, or any other suitable memory that stores and provides instructions for performing various functions described herein. The instructions may include code from any suitable programming language. The controller 233 may communicate with or may be implemented as part of an engine control unit (ECU) of an internal combustion engine. In one configuration, the controller 233 is communicatively coupled to the pump 220 and the doser 260. In this configuration, the controller 233 may receive the sensor measurement data indicating the detected pressure measurement value from the doser 260, and generate signals or commands to configure the pump 220 and the doser 260 according to the sensor measurement data.

In one aspect, the controller 233 generates the commands for controlling the pump 220 and the doser 260, according to a pump flow model. The pump flow model can be represented as below:

$$( D - s P ) Ω = ( {A}_{ret} + δ {A}_{i n j} ) \sqrt{\frac{2 Y P}{{ρ}_{fluid}}} \qquad Eq . ( 1 )$$

where Aᵣₑₜ is an effective orifice area of the return orifice 212, Aᵢₙⱼ is an effective orifice area of the injector 214, δ is an injector duty cycle, ρ_{fluid} is fluid density, γ is specific gravity, P is the pressure measurement value, Ω is a pump speed, and D is a displacement amount of reductant by the pump 220. The controller 233 may generate an electrical signal or a command to configure an opening of the injector 214 or a duty cycle of the opening and closing of the injector 214, such that the injector 214 can have or operate with the effective orifice area Aᵢₙⱼ. Moreover, the controller 233 may generate an electrical signal or a command to configure the pump 220 to dose reductant into the doser 260 at a pump speed Ω. In one aspect, the controller 233 may receive a target pressure P_{target}, and automatically sets, adjusts or determines the effective orifice area Aᵣₑₜ of the return orifice 212, the effective orifice area Aᵢₙⱼ of the injector 214, and the pump speed Ω based on the pump flow model or Eq. (1) to achieve the target pressure P_{target}. Then, the controller 233 may generate electrical signals or commands corresponding to the effective orifice area Aᵣₑₜ of the return orifice 212, the effective orifice area Aᵢₙⱼ of the injector 214, and the pump speed Ω. The controller 233 may transmit the electrical signals or commands to the pump 220 and the doser 260, such that the pump 220 and the doser 260 can operate as indicated by the electrical signal or commands.

In one aspect, controlling the aftertreatment system 200 to operate at the target pressure P_{target} may correct errors due to variations in pumps 220. For example, the controller 233 may determine the effective orifice area Aᵣₑₜ of the return orifice 212, the effective orifice area Aᵢₙⱼ of the injector 214, and the pump speed Ω to achieve the target pressure P_{target} according to the pump flow model or Eq. (1). The controller 233 may configure the pump 220 and the doser 260 to operate according to the determined effective orifice area Aᵣₑₜ of the return orifice 212, the effective orifice area Aᵢₙⱼ of the injector 214, and the pump speed Ω. The controller 233 may obtain a pressure measurement value from the pressure sensor 268 while the pump 220 and the doser 260 operate according to the determined values. Then, the controller 233 may compare the difference between the target pressure P_{target} and the pressure measurement value, and determine whether the doser 260 is over-dosing or under-dosing according to the difference. Based on the difference, the controller 233 may configure the pump 220, the doser 260, or both to compensate for the over-dosing or under-dosing. While controlling the aftertreatment system 200 based on the pressure sensor measurements alone may correct errors due to pump-to-pump variations, it may be insufficient to correct errors due to variations in dosers 260 or variations due to installation.

Controlling the aftertreatment system 200 based on the pressure sensor measurements alone may become more difficult, when the pressure sensor 268 is trimmed or adjusted. In some cases, the pressure sensor 268 is trimmed or adjusted to correct errors or variations in the pressure sensor 268. For example, the pressure measurement value output by the pressure sensor 268 can be adjusted by an offset pressure value ΔP corresponding to errors or variations in the pressure sensor 268. Operating the doser 260 with the adjusted pressure sensor may help improve dosing accuracy, but the offset pressure value ΔP may cause an inaccuracy in estimating effective orifice area Aᵢₙⱼ of the injector 214. Often, the pressure measurement value is internally adjusted or trimmed by a manufacture of the doser 260, and the offset pressure value ΔP may be unknown. Without knowing the offset pressure value ΔP, determining the accurate value of the effective orifice area Aᵢₙⱼ of the injector 214 may be difficult, and inaccurate estimation of the effective orifice area Aᵢₙⱼ may cause inaccuracy in controlling the aftertreatment system 200.

In some embodiments, the controller 233 obtains two pump speeds of the pump 220 operating in different modes, and control the pump 220 and the doser 260 based on the two pump speeds. In one aspect, the controller 133 obtains the different pump speeds in different modes: an idle mode and a dosing mode. In the idle mode, the pump 220 supplies the reductant from the reductant tank 218 to the doser 260 at steady state, the doser 260 does not dose the reductant, and the reductant supplied to the doser 260 by the pump 220 is recirculated to the reductant tank 218. In the dosing mode, the pump 220 supplies the reductant to the doser 260, and the doser 160 doses the reductant into the decomposition chamber 104 at steady state. In one aspect, a first speed Ω₁ of the pump 220 required to achieve the target pressure P_{target} can be determined, while the pump 220 and the doser 260 operate in the idle mode. In addition, a second speed Ω₂ of the pump 220 required to achieve the target pressure P_{target} can be determined, while the pump 220 and the doser 260 operate in the dosing mode. Based on the first speed Ω₁ and the second speed Ω₂ obtained in different modes, the offset pressure value ΔP, the effective orifice area Aᵢₙⱼ of the injector 214, the displacement amount D, or any combination of them to configure the pump 220 and the doser 260 can be determined. Based on the determined values, the controller 233 may control the aftertreatment system 200 with improved accuracy.

### III. Aftertreatment System Including Non-Trimmed Doser

In some embodiments, the controller 233 may obtain pump speeds Ω₁, Ω₂, and determine an effective orifice area Aᵢₙⱼ of the injector 214 and the displacement amount D, according to the pump speeds Ω₁, Ω₂. Moreover, the controller 233 may determine adjusted injector duty cycle δ_{adj} to adjust an on-off duty cycle of the injector 214, according to the effective orifice area Aᵢₙⱼ of the injector 214.

In one aspect, the controller 233 may configure the aftertreatment system 200 to operate in the idle mode. In the idle mode, the pump 220 supplies the reductant from the reductant tank 218 to the doser 260 at steady state, the doser 260 does not dose the reductant, and the reductant supplied to the doser 260 by the pump 220 is recirculated to the reductant tank 218. In the idle mode, the effective orifice area Aᵢₙⱼ of the injector 214 may be zero, and the pump flow model or Eq. (1) can be expressed as below:

$$( D - {sP}_{targ e t} ) {Ω}_{1} = {A}_{ret \_ nom} \sqrt{\frac{2 Y {P}_{target}}{{ρ}_{fluid}}} \qquad Eq . ( 2 )$$

where Ω₁ is the pump speed required to achieve the target pressure P_{target} in the idle mode, and A_{ret_nom} is a nominal return orifice area of the return orifice 212. Hence, the controller 233 may determine the displacement amount D as below.

$$D = {A}_{ret \_ nom} \sqrt{\frac{2 Y {P}_{t a r g e t}}{{ρ}_{f l u i d}}} / {Ω}_{1} + s {P}_{targ e t} \qquad Eq . ( 3 )$$

In one aspect, the controller 233 may configure the aftertreatment system 200 to operate in the dosing mode. In the dosing mode, the pump 220 supplies the reductant to the doser 260, and the doser 260 doses the reductant into the decomposition chamber 104 at steady state. In the dosing mode, the pump flow model or Eq. (1) can be expressed as below:

$$( D - s {P}_{targ e t} ) {Ω}_{2} = ( {A}_{ret \_ nom} + δ {A}_{i n j} ) \sqrt{\frac{2 Y {P}_{t a r g e t}}{{ρ}_{f l u i d}}} \qquad Eq . ( 4 )$$

where Ω₂ is the pump speed required to achieve the target pressure P_{target} in the dosing mode. Furthermore, the controller 233 may determine the effective orifice area Aᵢₙⱼ of the injector 214 based on the displacement amount D as below.

$${A}_{i n j} = \frac{( D - {sP}_{t a r g e t} ) ( {Ω}_{2} - {Ω}_{1} )}{δ \sqrt{\frac{2 Y {P}_{targ e t}}{{ρ}_{f l u i d}}}} \qquad Eq . ( 5 )$$

Moreover, the controller 233 may determine adjusted injector duty cycle δadj to adjust an on-off duty cycle of the injector 214 based on the effective orifice area Aᵢₙⱼ of the injector 214 as below:

$${δ}_{adj} = δ \frac{{A}_{inj \_ nom}}{{A}_{i n j}} \qquad Eq . ( 6 )$$

where A_{inj_nom} is a nominal orifice area of the injector 214. The controller 233 may adjust on/off duration of the injector 214 according to the adjusted injector duty cycle δ_{adj}, such that the accuracy of the doser 260 can be improved despite variations in the doser 260 or variations due to installation process.

### IV. Aftertreatment System Including Trimmed Doser

In some embodiments, the controller 233 may obtain pump speeds Ω₁, Ω₂, and determine an offset pressure value ΔP, an effective orifice area Aᵢₙⱼ of the injector 214 and the displacement amount D, according to the pump speeds Ω₁, Ω₂. Moreover, the controller 233 may determine adjusted injector duty cycle δadj to adjust an on-off duty cycle of the injector 214, according to the effective orifice area Aᵢₙⱼ of the injector 214.

In one aspect, the controller 233 may configure the aftertreatment system 200 to operate in the idle mode. In the idle mode, the pump 220 supplies the reductant from the reductant tank 218 to the doser 260 at steady state, the doser 260 does not dose the reductant, and the reductant supplied to the doser 260 by the pump 220 is recirculated to the reductant tank 218. In the idle mode, the effective orifice area Aᵢₙⱼ of the injector 214 may be zero, and the pump flow model or Eq. (1) can be expressed as below.

$$( D - s ( {P}_{targ e t} + Δ P ) ) Ω 1 = {A}_{r e f} \sqrt{\frac{2 Y ( {P}_{t a r g e t} + Δ P )}{{ρ}_{f l u i d}}} \qquad Eq . ( 7 )$$

In one aspect, the controller 233 may configure the aftertreatment system 200 to operate in the dosing mode. In the dosing mode, the pump 220 supplies the reductant to the doser 260, and the doser 260 doses the reductant into the decomposition chamber 104 at steady state. In the dosing mode, the pump flow model or Eq. (1) can be expressed as below.

$$( D - s ( {P}_{target} + Δ P ) ) {Ω}_{2} = ( {A}_{ret} + δ {A}_{inj} ) \sqrt{\frac{2 Υ ( {P}_{target} + Δ P )}{{ρ}_{fluid}}} \qquad Eq . ( 8 )$$

Based on the difference between Eq. (7) and Eq. (8), the controller 233 may determine the offset pressure value ΔP as below.

$$Δ P = {P}_{target} ( {( \frac{{Ω}_{1} δ {A}_{inj \_ nom}}{( {Ω}_{2} - {Ω}_{1} ) {A}_{ret}} )}^{2} - 1 ) \qquad Eq . ( 9 )$$

Furthermore, the controller 233 may determine the effective orifice area Aᵢₙⱼ of the injector 214 based on the offset pressure value ΔP as below.

$${A}_{inj} = {A}_{inj \_ nom} / \sqrt{1 + \frac{Δ P}{{P}_{target}}} \qquad Eq . ( 10 )$$

In addition, the controller 233 may determine the displacement amount D based on the offset pressure value ΔP as below.

$$D = s ( {P}_{target} + Δ P ) + Aret / {Ω}_{1} \sqrt{\frac{2 Υ ( {P}_{target} + Δ P )}{{ρ}_{fluid}}} \qquad Eq . ( 11 )$$

In one aspect, the offset pressure value ΔP, the effective orifice area Aᵢₙⱼ of the injector 214, and the displacement amount D allow the controller 233 to control the aftertreatment system 200 with improved accuracy, despite the offset pressure value ΔP.

### V. Example Operation of Reductant Delivery System

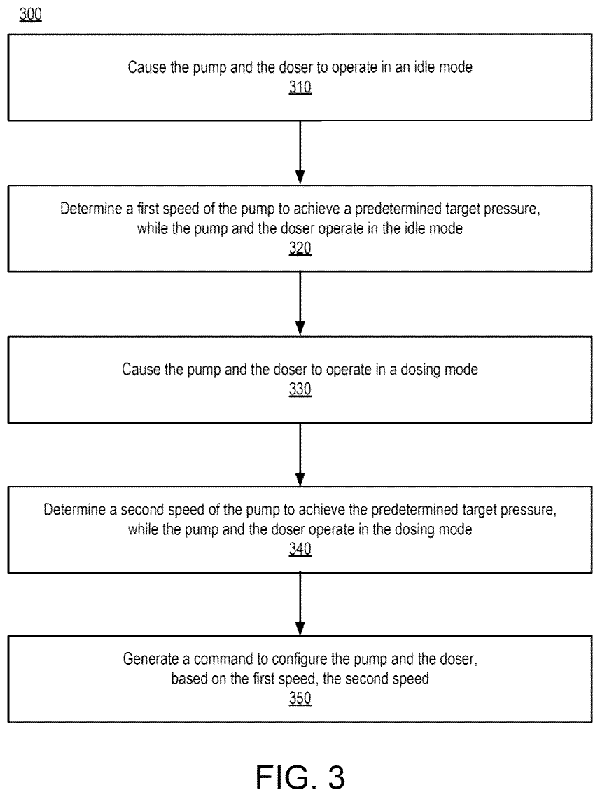

FIG. 3 is a flow chart showing an example process 300 of operating the aftertreatment system 100 or 200 based on different pump speeds Ω₁, Ω₂ obtained in different modes. In some embodiments, the process 300 is performed by the controller 233. In some embodiments, the process 300 is performed by other entities (e.g., another control device). In some embodiments, the process 300 includes more, fewer, or different steps than shown in FIG. 3. For example, the pump speeds Ω₁, Ω₂ may be obtained in a different sequence than shown in FIG. 3.

In a step 310, the controller 233 causes the pump 220 and the doser 260 to operate in an idle mode. In the idle mode, the pump 220 supplies the reductant from the reductant tank 218 to the doser 260 at steady state, the doser 260 does not dose the reductant, and the reductant supplied to the doser 260 by the pump 220 is recirculated to the reductant tank 218.

In a step 320, the controller 233 determines a first speed Ω₁ of the pump 220 to achieve a predetermined target pressure P_{target}, while the pump 220 and the doser 260 operate in the idle mode.

In a step 330, the controller 233 causes the pump 220 and the doser 260 to operate in a dosing mode. In the dosing mode, the pump 220 supplies the reductant to the doser 260, and the doser 260 doses the reductant into the decomposition chamber 104 at steady state.

In a step 340, the controller 233 determines a second speed Ω₂ of the pump 220 to achieve the predetermined target pressure P_{target}, while the pump 220 and the doser 260 operate in the dosing mode.

In a step 350, the controller 233 generates a command to configure the pump 220 and the doser 260, based on the first speed Ω₁ and the second speed Ω₂. In one approach, the controller 233 may determine the offset pressure value ΔP based on the first speed Ω₁ and the second speed Ω₂, according to Eq. (9). Based on the offset pressure value ΔP, the controller 233 may determine the effective orifice area Aᵢₙⱼ of the injector 214 according to Eq. (10). In addition, based on the offset pressure value ΔP, the controller 233 may determine the displacement amount D according to Eq. (11). The controller 233 may update the pump flow model, according to the determined values (e.g., the offset pressure value ΔP, the effective orifice area Aᵢₙⱼ of the injector 214, and the displacement amount D), and generate a command based on the updated pump flow model to control the aftertreatment system 100 or 200 with improved accuracy.

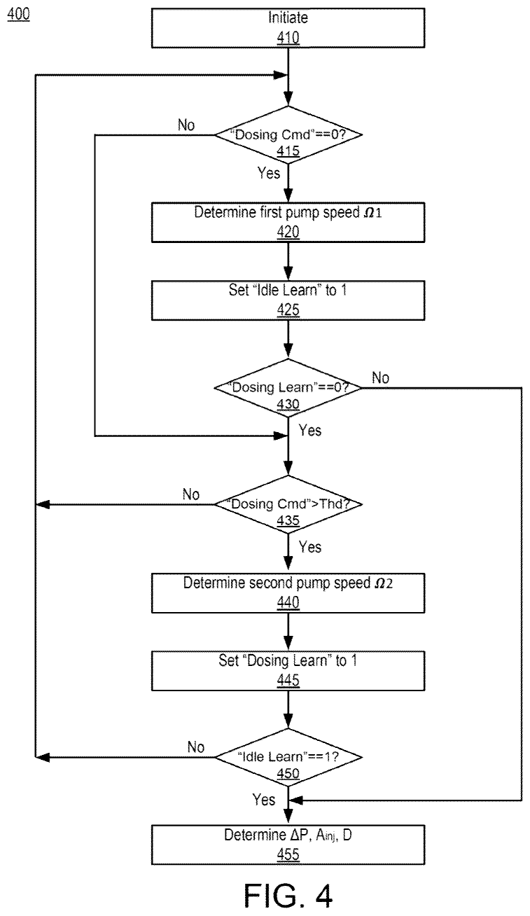

FIG. 4 is a flow chart showing an example process 400 of operating the aftertreatment system 100 or 200 based on different pump speeds Ω₁, Ω₂ obtained in different modes. In some embodiments, the process 400 is performed by the controller 233. In some embodiments, the process 400 is performed by other entities. In some embodiments, the process 400 includes more, fewer, or different steps than shown in FIG. 4.

In a step 410, the controller 233 initiates the process 400. The controller 233 may initiate the process 400 once when the aftertreatment system 100 or 200 is first deployed, before deploying the aftertreatment system 100 or 200, or when the pump 220 or the doser 260 is installed. When the controller 233 initiates the process 400, variables such as Dosing Cmd, Idle Learn, Dosing Learn can be set to initial values (e.g., ‘0’). The controller 233 may store the variables or indicators Dosing Cmd, Idle Learn, Dosing Learn in the memory of the controller 233. Dosing Cmd may be an indicator that indicates whether the doser 260 is dosing reductant into the decomposition chamber 104. Idle Learn may be an indicator that indicates whether the first speed Ω₁ of the pump 220 in the idle mode is determined or not. Dosing Learn may be an indicator that indicates whether the second speed Ω₂ of the pump 220 in the dosing mode is determined or not.

In a step 415, the controller 233 determines whether Dosing Cmd has a value of ‘0’. Dosing Cmd having the value ‘0’ may indicate that the aftertreatment system 100 or 200 operates in the idle mode, whereas Dosing Cmd having a value different from ‘0’ may indicate that the aftertreatment system 100 or 200 operates in the dosing mode. In response to Dosing Cmd having the value different from ‘0’, the controller 233 may proceed to a step 435. In response to Dosing Cmd having the value ‘0’, the controller 233 may wait for the pump speed to stabilize. In a step 420, when the pump speed stabilizes in the idle mode to achieve the target pressure P_{target}, the controller 233 may determine the pump speed Ω₁ of the pump 220. In a step 425, in response to determining the pump speed Ω₁ of the pump 220, the controller 230 may set Idle Learn to have a value ‘1’. Idle Learn having the value ‘0’ may indicate that the pump speed Ω₁ of the pump 220 operating in the idle mode is not determined yet, whereas Idle Learn having the value ‘1’ may indicate that the pump speed Ω₁ of the pump 220 operating in the idle mode is determined.

In a step 430, after setting the Idle Learn to have the value ‘1’ in the step 425, the controller 233 may determine whether Dosing Learn has a value of ‘0’. Dosing Learn having the value ‘0’ may indicate that the pump speed Ω₂ of the pump 220 in the dosing mode is not determined yet, whereas Dosing Learn having the value ‘1’ may indicate that the pump speed Ω₂ of the pump 220 in the dosing mode is determined. In a step 455, in response to determining that Dosing Learn does not have the value ‘0’ (or has the value ‘1’), the controller 233 may determine the offset pressure value ΔP, the effective orifice area Aᵢₙⱼ of the injector 214, and the displacement amount D, according to Eq. (9)-(11). According to the offset pressure value ΔP, the effective orifice area Aᵢₙⱼ of the injector 214, and the displacement amount D, the controller 233 may update the pump flow model or Eq. (1) to improve accuracy of the aftertreatment system 100 or 200. Moreover, the controller 233 may generate electrical signals or commands to operate the pump 220 and the doser 260 according to the updated pump flow model.

In the step 435, In response to determining that Dosing Learn has the value ‘0’ in the step 430, the controller 233 may determine whether Dosing Cmd is larger than a threshold value. The threshold value may be predetermined or adjusted. In one aspect, Dosing Cmd having a value larger than the threshold value may indicate that sufficient reductant is provided to the decomposition chamber 104 to measure the pump speed Ω₂ in the dosing mode, whereas Dosing Cmd having a value less than or equal to the threshold value may indicate that insufficient reductant is provided to the decomposition chamber 104 to measure the pump speed Ω₂ in the dosing mode. As such, in response to determining that Dosing Cmd has a value less than or equal to the threshold value, the controller 233 may proceed to the step 415. In response to determining that Dosing Cmd has a value larger than the threshold value, the controller 233 may wait for the pump speed to stabilize in the dosing mode. In a step 440, when the pump speed stabilizes in the dosing mode to achieve the target pressure P_{target}, the controller 233 may determine the pump speed Ω₂ of the pump 220. In a step 445, in response to determining the pump speed Ω₂ of the pump 220, the controller 230 may set Dosing Learn to have a value ‘1’.

In a step 450, after setting the Dosing Learn to have the value ‘1’ in the step 445, the controller 233 may determine whether Idle Learn has a value of ‘1’. In response to determining that Idle Learn does not have the value ‘1’, the controller 233 may proceed to the step 415. In the step 455, in response to determining that Idle Learn has the value ‘1’, the controller 233 may determine the offset pressure value ΔP, the effective orifice area Aᵢₙⱼ of the injector 214, and the displacement amount D, according to Eq. (9)-(11). According to the offset pressure value ΔP, the effective orifice area Aᵢₙⱼ of the injector 214, and the displacement amount D, the controller 233 may update the pump flow model or Eq. (1) to improve accuracy of the aftertreatment system 100 or 200. Moreover, the controller 233 may generate electrical signals or commands to operate the pump 220 and the doser 260 according to the updated pump flow model.

### VI. Overview of Aftertreatment System Including Two Dosers

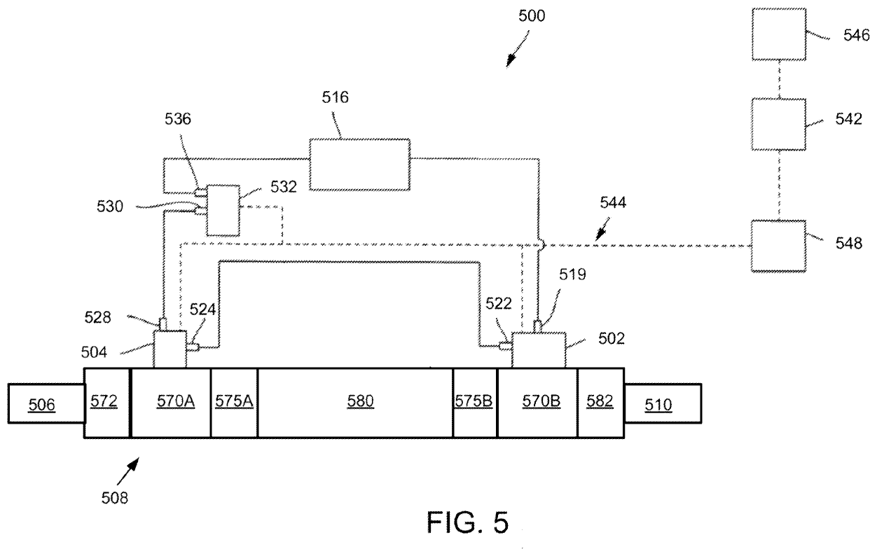

FIG. 5 depicts an aftertreatment system 500 that includes a doser 502 and a doser 504. The doser 502 may function as the doser 112 of FIG. 1 as described above. Prior to entering the doser 504, the flow of fluid may be regulated by a valve (e.g., a restriction valve, etc.), an orifice, or other similar structure. Alternatively, the flow of fluid is controlled by a component of the aftertreatment system 500 that is downstream of the doser 504.

The aftertreatment system 500 includes an inlet exhaust section 506, an aftertreatment component 508 which is in fluid communication with the inlet exhaust section 506, and an outlet exhaust section 510 which is in fluid communication with the aftertreatment component 508. The inlet exhaust section 506 receives exhaust from an internal combustion engine (e.g., via an exhaust manifold, etc.). The outlet exhaust section 510 provides the exhaust from the internal combustion engine downstream, such as to a tailpipe, a muffler, or other similar structure.

The aftertreatment component 508 is configured to cooperatively treat the exhaust received from the internal combustion engine such that emissions produced by the aftertreatment component 508 are more desirable. For example, the aftertreatment component 508 may reduce the level of NOx in the exhaust. In this way, a system (e.g., a vehicle, a generator, a maritime vessel, etc.) utilizing an internal combustion engine having the aftertreatment system 500 may be more desirable than similar systems without the aftertreatment system 500.

In one configuration, the doser 502, the doser 504, the reductant tank 516 and the pump 532 are in fluid communication. For example, the reductant tank 516 is fluidly coupled to an inlet 536 of the pump 532. For example, an outlet 530 of the pump 532 is fluidly coupled to an inlet 528 of the doser 504. For example, an outlet 524 of the doser 504 is fluidly coupled to an inlet 522 of the doser 502. For example, an outlet 519 of the doser 502 is fluidly coupled to the reductant tank 516.

The pump 532 functions to draw reductant from the reductant tank 516 and provide the reductant to the doser 502 and the doser 504. In one embodiment, the pump 532 is configured such that the reductant from the reductant tank 516 is provided to the inlet 528 of the doser 504 and remaining reductant is provided from the outlet 524 of the doser 504 to the inlet 522 of the doser 502. Then, remaining reductant from the outlet 519 of the doser 502 is returned to the reductant tank 516.

The aftertreatment component 508 may be divided into a number of sections 572, 570A, 575A, 580, 575B, 570B, and 582. In some embodiments, the aftertreatment component 508 may include more or less sections. The section 572 is an inlet of the aftertreatment component 508, and the section 582 is an outlet of the aftertreatment component 508. In some embodiments, the section 572 includes a DOC; the section 570A includes a mixer; the section 575A includes a SCR; the section 580 includes a DPF (or a cDPF); the section 575B includes a SCR; the section 570B includes a mixer 570B; and the section 582 includes a slip catalyst (e.g., an ammonia slip catalyst (ASC)).

As shown in FIG. 5, the aftertreatment system 500 also includes an engine control unit 542. The engine control unit 542 is electronically communicable with the doser 502, the doser 504, and the pump 532 via a communications network 544. The communications network 544 facilitates transmission of signals between any of the engine control unit 542, the doser 502, the doser 504, and the pump 532. For example, the engine control unit 542 may transmit a signal to the doser 502 and the doser 504 that causes the doser 502 and/or the doser 504 to dose the exhaust. The signals transmitted from the engine control unit 542 may include, for example, a dosing amount, a dosing duration, a pumping command (e.g., to the pump 532, etc.), and other similar commands.

In some embodiments, the aftertreatment system 500 also includes a parameters unit 546 which is electronically communicable with the communications network 544. The parameters unit 546 may provide information (e.g., stored parameters, sensed parameters, etc.) to the engine control unit 542. For example, the parameters unit 546 may be electronically communicable with various sensors such that the parameters unit 546 receives information from various components within the aftertreatment system 500. In some applications, the parameters unit 546 receives a level (e.g., amount, percentage of maximum capacity, etc.) of reductant within the reductant tank 516, a temperature (e.g., a temperature of the inlet exhaust section 506, a temperature of the doser 504, a temperature within the aftertreatment component 508, a temperature of doser 502, a temperature of the outlet exhaust section 510, etc.), a quality of the reductant (e.g., a concentration of the reductant, etc.), a level of a component (e.g., NOx, NH₃, etc.), and other similar information. The parameters unit 546 may include a memory and a processing circuit. The parameters unit 546 may include configuration data that is stored on the memory, the configuration data related to a configuration of the aftertreatment system 500 (e.g., sections 572, 570A, 575A, 580, 575B, 570B, 582, etc.).

The aftertreatment system 500 may also include a dosing control unit 548 which is electronically communicable with the communications network 544. The dosing control unit 548 may provide localized control of the doser 502, the doser 504, and/or the pump 532.

In one aspect, the aftertreatment component 508 operates as the two SCR system including the section 575A, 575B. The two SCR system may operate to reduce emissions as early as possible when engine has a cold start. The first SCR in the section 575A can work with lower temperature than the second SCR in the section 575B.

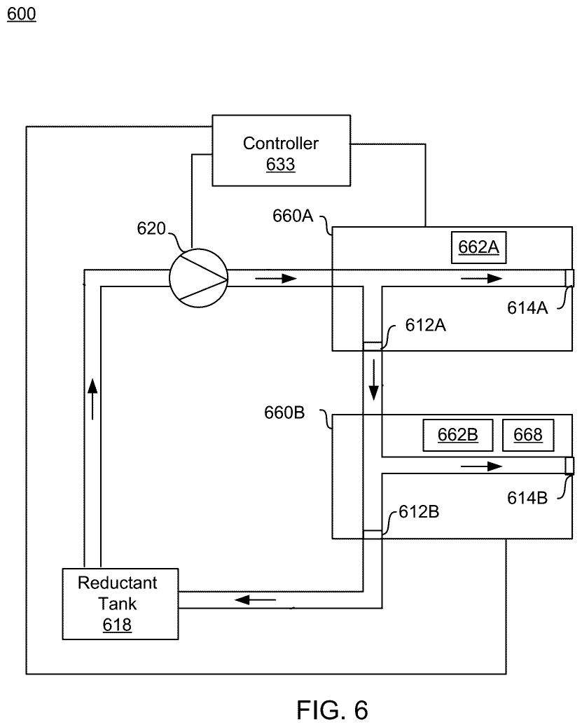

FIG. 6 depicts an aftertreatment system 600 for reducing NOₓ emissions. In some embodiments, the aftertreatment system 600 is implemented as or corresponds to the aftertreatment system 500 of FIG. 5. In this embodiment, a reductant tank 618 corresponds to the reductant tank 516, a pump 620 corresponds to the pump 532, a doser 660A corresponds to the doser 504, a doser 660B corresponds to the doser 502, and a controller 633 corresponds to the dosing control unit 548. The aftertreatment system 600 is similar to the aftertreatment system 200 of FIG. 2, except the aftertreatment system 600 includes two dosers 660A, 660B instead of the single doser 260. Thus, detailed description of duplicated portion thereof is omitted herein for the sake of brevity. In some embodiments, the aftertreatment system 600 includes more, fewer, or different components than shown in FIG. 6. For example, the aftertreatment system 600 includes one or more decomposition chambers (or mixers 570A, 570B), and each of the dosers 660A, 660B may be coupled to or mounted on a corresponding decomposition chamber (or a corresponding mixer 570A, 570B).

In one configuration, the dosers 660A, 660B are fluidly coupled between the pump 620 and the reductant tank 618 in series. The pump 620 and the reductant tank 618 may correspond to the pump 220 and the reductant tank 218, respectively. The doser 660A may be directly coupled to a first inlet of the mixer 570A, and the doser 660B may be directly coupled to a second inlet of the mixer 570B. In one configuration, the controller 633 is communicatively coupled to the pump 620, and the dosers 660A, 660B through a wired medium (e.g., conductive trace or wire) or a wireless medium (e.g., wireless link such as Wi-Fi, cellular, Bluetooth, etc.). In this configuration, the controller 633 may generate electrical signals or commands to operate the pump 620, the dosers 660A, 660B, or any combination of them to dose reductant into one or more decomposition chambers (or mixers 570A, 570B).

The doser 660A is a component that provides or doses the reductant from the pump 620 into a decomposition chamber (or mixer 570A). The doser 660A may be directly mounted on the first inlet of the decomposition chamber (mixer 570A). In one configuration, the doser 660A includes an inlet fluidly coupled to the outlet of the pump 620, a first outlet fluidly coupled to an inlet of the doser 660B, a second outlet directly coupled to a first inlet of the decomposition chamber (or mixer 570A), and internal pipelines connected between the inlet and the outlets. The doser 660A includes an injector 614A disposed at the second outlet of the doser 660A, through which some of the reductant from the inlet can be dosed or provided to the decomposition chamber (or mixer 570A). The doser 660A also includes a return orifice 612A of the first outlet of the doser 660A, through which remaining reductant not provided to the decomposition chamber (or mixer 570A) can be provided to the doser 660B. In some embodiments, the doser 660A does not include a pressure sensor. The doser 660A may also include an interface circuit 662A communicatively coupled to the controller 633 and internal devices such as the injector 614A. In this configuration, the interface circuit 662A may receive an electrical signal or command from the controller 633, and configure opening or closing of the injector 614A according to the electrical signal or command. By adjusting amounts of opening or a duty cycle of opening and closing of the injector 614A, a desired amount of reductant can be provided to the decomposition chamber (or mixer 570A).

The doser 660B is a component that provides or doses the reductant from the doser 660A into a decomposition chamber (or mixer 570B). The doser 660B may be directly mounted on the decomposition chamber (or mixer 570B). In one configuration, the doser 660B includes an inlet fluidly coupled to the first outlet of the doser 660A, a first outlet fluidly coupled to the inlet of the reductant tank 618, a second outlet directly coupled to a second inlet of the decomposition chamber (or mixer 570B), and internal pipelines connected between the inlet and the outlets. The doser 660B includes an injector 614B disposed at the second outlet of the doser 660B, through which some of the reductant from the doser 660A can be dosed or provided to the decomposition chamber (or mixer 570B). The doser 660B also includes a return orifice 612B of the first outlet of the doser 660B, through which remaining reductant not provided to the decomposition chamber (or mixer 570B) can be recirculated back to the reductant tank 618. In some embodiments, the doser 660B includes a pressure sensor 668 that detects pressure within the doser 660B (e.g., pressure within the internal pipelines) and generates an electrical signal corresponding to the pressure measurement value. The doser 660B may also include an interface circuit 662B communicatively coupled to the controller 633 and internal devices such as the pressure sensor 668 and the injector 614B. In this configuration, the interface circuit 662B may receive an electrical signal or command from the controller 633, and configure opening or closing of the injector 614B according to the electrical signal or command. By adjusting amounts of opening or a duty cycle of opening and closing of the injector 614B, a desired amount of reductant can be provided to the decomposition chamber (or mixer 570B). In addition, the interface circuit 662B may receive the electrical signal corresponding to the pressure measurement value from the pressure sensor 668, and generate sensor measurement data indicating the pressure measurement value according to the electrical signal. The interface circuit 662B may transmit the sensor measurement data to the controller 633.

In one aspect, the controller 633 generates the commands for controlling the pump 620 and the dosers 660A, 660B, according to a pump flow model. The pump flow model can be represented as below:

$$( D - s ( {P}_{target} + Δ P ) ) Ω = ( {A}_{ret} + {δ}_{1} {A}_{inj 1} + {δ}_{2} {A}_{inj 2} ) \sqrt{\frac{2 Υ ( {P}_{target} + Δ P )}{{ρ}_{fluid}}} \qquad Eq . ( 12 )$$

where Aᵣₑₜ is an effective orifice area of the return orifice 612, Aᵢₙⱼ₁ is an effective orifice area of the injector 614A, Aᵢₙⱼ₂ is an effective orifice area of the injector 614B, δ₁ is an injector duty cycle of the injector 614A, δ₂ is an injector duty cycle of the injector 614B, ρ_{fluid} is fluid density, γ is specific gravity, P is the pressure measurement value, Ω is a pump speed, and D is a displacement amount of reductant by the pump 620. The controller 633 may generate an electrical signal or a command to configure openings of the injectors 614A, 614B or duty cycles of the opening and closing of the injectors 614A, 614B, such that the injectors 614A, 614B can have or operate with the effective orifice areas Aᵢₙⱼ₁, Aᵢₙⱼ₂. Moreover, the controller 633 may generate an electrical signal or a command to configure the pump 620 to provide reductant to the dosers 660A, 660B at a pump speed Ω. In one aspect, the controller 633 may receive a target pressure P_{target}, and automatically sets, adjusts or determines the effective orifice area Aᵢₙⱼ₁ of the injector 614A, the effective orifice area Aᵢₙⱼ₂ of the injector 614B, and the pump speed Ω based on the pump flow model or Eq. (12) to achieve the target pressure P_{target}. Then, the controller 633 may generate electrical signals or commands corresponding to the effective orifice area Aᵢₙⱼ₁ of the injector 614A, the effective orifice area Aᵢₙⱼ₂ of the injector 614B, and the pump speed Ω. The controller 633 may transmit the electrical signals or commands to the pump 620 and the dosers 660A, 660B, such that the pump 620 and the dosers 660A, 660B can operate as indicated by the electrical signal or commands.

In some embodiments, the controller 633 obtains three pump speeds of the pump 620 operating in different modes, and control the pump 620 and the dosers 660A, 660B based on the three pump speeds. In one aspect, the controller 633 obtains the different pump speeds in different modes: an idle mode, a first dosing mode, and a second dosing mode. In the idle mode, the pump 620 supplies the reductant from the reductant tank 618 to the first doser 660A at steady state, the first doser 660A and the second doser 660B do not dose the reductant, and the reductant supplied to the first doser 660A and the second doser 660B by the pump 620 is recirculated to the reductant tank 618. In the first dosing mode, the pump 620 supplies the reductant to the first doser 660A, the first doser 660A doses the reductant into the decomposition chamber (or mixer 570A) at steady state, and the second doser 660B does not dose the reductant. In the second dosing mode, the pump 620 supplies the reductant to the first doser 660A, the first doser 660A does not dose the reductant, and the second doser 660B doses the reductant into the decomposition chamber (or mixer 570B) at steady state. In one aspect, a first speed Ω₁ of the pump 620 required to achieve the target pressure P_{target} can be determined, while the pump 620 and the dosers 660A, 660B operate in the idle mode. In addition, a second speed Ω₂ of the pump 620 required to achieve the target pressure P_{target} can be determined, while the pump 620 and the dosers 660A, 660B operate in the first dosing mode. In addition, a third speed Ω₃ of the pump 620 required to achieve the target pressure P_{target} can be determined, while the pump 620 and the dosers 660A, 660B operate in the second dosing mode. Based on the first speed Ω₁, the second speed Ω₂, and the third speed Ω₃ obtained in different modes, the offset pressure value ΔP, the effective orifice areas Aᵢₙⱼ₁, Aᵢₙⱼ₂ of the injectors 614A, 614B, the displacement amount D, or any combination of them to configure the pump 620 and the dosers 660A, 660B can be determined. Based on the determined values, the controller 633 may control the aftertreatment system 600 with improved accuracy.

### VII. Aftertreatment System Including Trimmed Doser

In some embodiments, the controller 633 may obtain pump speeds Ω₁, Ω₂, Ω₃ and determine an offset pressure value ΔP, effective orifice areas Aᵢₙⱼ₁, Aᵢₙⱼ₂ of the injectors 614A, 614B and the displacement amount D, according to the pump speeds Ω₁, Ω₂, Ω₃. Moreover, the controller 633 may determine adjusted injector duty cycle δ_{adj1} to adjust an on-off duty cycle of the injector 614A, according to the effective orifice area Aᵢₙⱼ₁ of the injector 614A. Similarly, the controller 633 may determine adjusted injector duty cycle δ_{adj2} to adjust an on-off duty cycle of the injector 614B, according to the effective orifice area Aᵢₙⱼ₂ of the injector 614B.

In one aspect, the controller 633 may configure the aftertreatment system 600 to operate in the idle mode. In the idle mode, the pump 620 supplies the reductant from the reductant tank 618 to the first doser 660A at steady state, the first doser 660A and the second doser 660B do not dose the reductant, and the reductant supplied to the first doser 660A and the second doser 660B by the pump 620 is recirculated to the reductant tank 618. In the idle mode, the effective orifice areas Aᵢₙⱼ₁, Aᵢₙⱼ₂ of the injectors 614A, 614B may be zero, and the pump flow model or Eq. (13) can be expressed as below.

$$( D - s ( {P}_{target} + Δ P ) ) {Ω}_{1} = {A}_{ret \_ nom} \sqrt{\frac{2 Υ ( {P}_{target} + Δ P )}{{ρ}_{fluid}}} \qquad Eq . ( 13 )$$

where Ω₁ is the pump speed required to achieve the target pressure P_{target} in the idle mode, and A_{ret_nom} is a nominal return orifice area of the return orifice 612B.

In one aspect, the controller 633 may configure the aftertreatment system 600 to operate in the first dosing mode. In the first dosing mode, the pump 620 supplies the reductant to the first doser 660A, the first doser 660A doses the reductant into the decomposition chamber (or mixer 570A) at steady state, and the second doser 660B does not dose the reductant. In the first dosing mode, the pump flow model or Eq. (14) can be expressed as below:

$$( D - s ( {P}_{target} + Δ P ) ) {Ω}_{2} = ( {A}_{ret \_ nom} + {δ}_{1} {A}_{inj 1} ) \sqrt{\frac{2 Υ ( {P}_{target} + Δ P )}{{ρ}_{fluid}}} \qquad Eq . ( 14 )$$

where Ω₂ is the pump speed required to achieve the target pressure P_{target} in the first dosing mode.

In one aspect, the controller 633 may configure the aftertreatment system 600 to operate in the second dosing mode. In the second dosing mode, the pump 620 supplies the reductant to the first doser 660A, the first doser 660A does not dose the reductant, and the second doser 660B doses the reductant into the decomposition chamber (or mixer 570B) at steady state. In the second dosing mode, the pump flow model or Eq. (15) can be expressed as below:

$$( D - s ( {P}_{target} + Δ P ) ) {Ω}_{3} = ( {A}_{ret \_ nom} + {δ}_{2} {A}_{inj 2} ) \sqrt{\frac{2 Υ ( {P}_{target} + Δ P )}{{ρ}_{fluid}}} \qquad Eq . ( 15 )$$

where Ω₃ is the pump speed required to achieve the target pressure P_{target} in the second dosing mode. Moreover, the effective orifice area Aᵢₙⱼ₂ of the injector 614B can be obtained as below:

$${A}_{inj 2} = {A}_{inj \_ nom} / \sqrt{1 + \frac{Δ P}{{P}_{target}}} \qquad Eq . ( 16 )$$

where A_{inj_nom} is a nominal injector orifice area of the injector 614B.

Based on Eq. (15) and Eq. (16), the controller 633 may determine the offset pressure value ΔP as below.

$$Δ P = {P}_{target} ( {( \frac{{Ω}_{1} {δ}_{2} {A}_{inj \_ nom}}{( {Ω}_{3} - {Ω}_{1} ) {A}_{ret \_ nom}} )}^{2} - 1 ) \qquad Eq . ( 17 )$$

In addition, the controller 633 may determine the displacement amount D based on the offset pressure value ΔP as below.

$$D = s ( {P}_{target} + Δ P ) + {A}_{ret} / {Ω}_{1} \sqrt{\frac{2 Υ ( {P}_{target} + Δ P )}{{ρ}_{fluid}}} \qquad Eq . ( 18 )$$

Furthermore, based on the difference between Eq. (13) and Eq. (14), the controller 633 may determine the effective orifice area Aᵢₙⱼ₁ of the injector 614A based on the displacement amount D as below.

$${A}_{inj 1} = ( D - {sP}_{target} ) ( {Ω}_{2} - {Ω}_{1} ) / ( {δ}_{1} \sqrt{\frac{2 Υ {P}_{target}}{{ρ}_{fluid}}} ) \qquad Eq . ( 19 )$$

Based on the effective orifice area Aᵢₙⱼ₁ of the injector 614A, the controller 633 may determine a dosing adjustment factor Inj1_{adj} to apply to the injector duty cycle δ₁ of the injector 614A as below.

$$Inj {1}_{adj} = \frac{{A}_{inj \_ nom}}{{A}_{inj 1}} \sqrt{\frac{{P}_{target}}{{P}_{target} + Δ P}} = \frac{{A}_{inj 2}}{{A}_{inj 1}} \qquad Eq . ( 20 )$$

For example, the controller 633 may multiply the injector duty cycle δ₁ of the injector 614A by the dosing adjustment factor Inj1_{adj} to obtain the adjusted injector duty cycle δ_{adj1}.

In one aspect, the offset pressure value ΔP, the effective orifice area Aᵢₙⱼ₁ of the injector 614A, the effective orifice area Aᵢₙⱼ₂ of the injector 614B, and the displacement amount D allow the controller 633 to control the aftertreatment system 600 with improved accuracy, despite the offset pressure value ΔP.

### VIII. Aftertreatment System Including Non-Trimmed Doser

In some embodiments, the controller 633 may obtain pump speeds Ω₁, Ω₂, Ω₃ and determine an effective orifice area Aᵢₙⱼ₁ of the injector 614A, an effective orifice area Aᵢₙⱼ₂ of the injector 614B, and the displacement amount D, according to the pump speeds Ω₁, Ω₂, Ω₃. Moreover, the controller 633 may determine adjusted injector duty cycle δ_{adj1} to adjust the duty cycle δ₁ of the injector 614A, according to the effective orifice area Aᵢₙⱼ₁ of the injector 614A. In addition, the controller 633 may determine adjusted injector duty cycle δ_{adj2} to adjust the duty cycle δ₂ of the injector 614B, according to the effective orifice area Aᵢₙⱼ₂ of the injector 614B.

In one aspect, the controller 633 may determine adjusted injector duty cycle δ_{adj1} to adjust the duty cycle δ₁ of the injector 614A based on the effective orifice area Aᵢₙⱼ₁ of the injector 614A as below.

$${δ}_{adj 1} = {δ}_{1} \frac{{A}_{inj \_ nom}}{{A}_{inj 1}} \qquad Eq . ( 21 )$$

Similarly, the controller 633 may determine adjusted injector duty cycle δ_{adj2} to adjust the duty cycle δ₂ of the injector 614B based on the effective orifice area Aᵢₙⱼ₂ of the injector 614B as below.

$${δ}_{adj 2} = {δ}_{2} \frac{{A}_{inj \_ nom}}{{A}_{inj 2}} \qquad Eq . ( 22 )$$

The controller 633 may adjust on/off duration of the injectors 614A, 614B according to the adjusted injector duty cycles δ_{adj1}, δ_{adj2}, such that the accuracy of the dosers 660A, 660B can be improved despite variations in the dosers 660A, 660B or variations due to installation process.

### IX. Example Operation of Reductant Delivery System

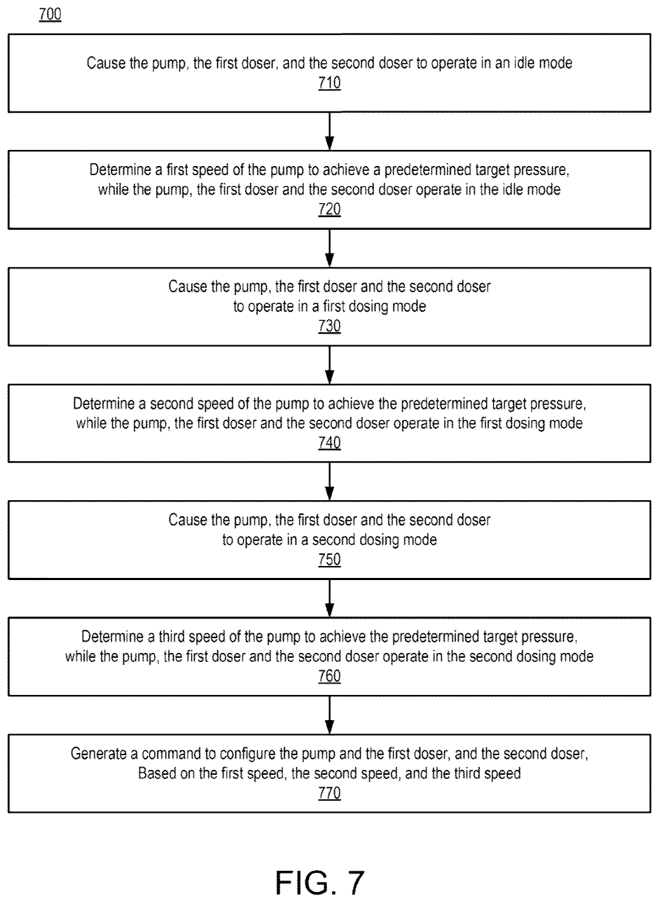

FIG. 7 is a flow chart showing an example process 700 of operating the aftertreatment system 500 or 600 based on different pump speeds Ω₁, Ω₂, Ω₃ obtained in different modes. In some embodiments, the process 700 is performed by the controller 633. In some embodiments, the process 700 is performed by other entities. In some embodiments, the process 700 includes more, fewer, or different steps than shown in FIG. 7. For example, the pump speeds Ω₁, Ω₂, Ω₃ may be obtained in a different sequence than shown in FIG. 7.

In a step 710, the controller 633 causes the pump 620 and the dosers 660A, 660B to operate in an idle mode. In the idle mode, the pump 620 supplies the reductant from the reductant tank 618 to the first doser 660A at steady state, the first doser 660A and the second doser 660B do not dose the reductant, and the reductant supplied to the first doser 660A and the second doser 660B by the pump 620 is recirculated to the reductant tank 618.

In a step 720, the controller 633 determines a first speed Ω₁ of the pump 620 to achieve a predetermined target pressure P_{target}, while the pump 620 and the dosers 660A, 660B operate in the idle mode.

In a step 730, the controller 633 causes the pump 620 and the dosers 660A, 660B to operate in a first dosing mode. In the first dosing mode, the pump 620 supplies the reductant to the first doser 660A, the first doser 660A doses the reductant into one or more decomposition chambers (or mixers 570A, 570B) at steady state, and the second doser 660B does not dose the reductant.

In a step 740, the controller 633 determines a second speed Ω₂ of the pump 620 to achieve the predetermined target pressure P_{target}, while the pump 620 and the dosers 660A, 660B operate in the second dosing mode.

In a step 750, the controller 633 causes the pump 620 and the dosers 660A, 660B to operate in a second dosing mode. In the second dosing mode, the pump 620 supplies the reductant to the first doser 660A, the second doser 660B doses the reductant into the decomposition chamber (or mixer 570B) at steady state, and the first doser 660A does not dose the reductant.

In a step 760, the controller 633 determines a third speed Ω₃ of the pump 620 to achieve the predetermined target pressure P_{target}, while the pump 620 and the dosers 660A, 660B operate in the third dosing mode.

In a step 770, the controller 633 generates a command to configure the pump 620 and the dosers 660A, 660B, based on the first speed Ω₁, the second speed Ω₂, and the third speed Ω₃. In one approach, the controller 633 may determine the offset pressure value ΔP based on the first speed Ω₁ and the third speed Ω₃, according to Eq. (17). In one approach, the controller 633 may determine the offset pressure value ΔP based on the first speed Ω₁ and the third speed Ω₃, according to Eq. (16). Based on the offset pressure value ΔP, the controller 633 may determine the effective orifice area Aᵢₙⱼ₂ of the injector 614B according to Eq. (16). In addition, based on the displacement amount D, the first speed Ω₁, and the second speed Ω₂, the controller 633 may determine the effective orifice area Aᵢₙⱼ₁ of the injector 614A according to Eq. (19). The controller 633 may update the pump flow model, according to the determined values (e.g., the offset pressure value ΔP, the effective orifice area Aᵢₙⱼ₁ of the injector 614A, the effective orifice area Aᵢₙⱼ₂ of the injector 614B, and the displacement amount D), and generate a command based on the updated pump flow model to control the aftertreatment system 500 or 600 with improved accuracy.

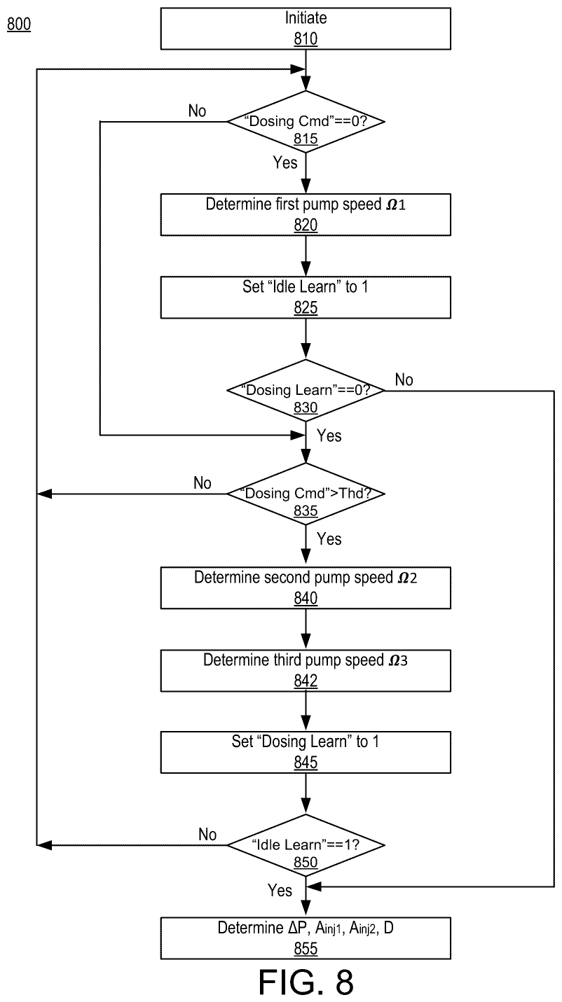

FIG. 8 is a flow chart showing an example process 800 of operating the aftertreatment system 500 or 600 based on different pump speeds Ω₁, Ω₂, Ω₃ obtained in different modes. In some embodiments, the process 800 is performed by the controller 633. In some embodiments, the process 800 is performed by other entities. In some embodiments, the process 800 includes more, fewer, or different steps than shown in FIG. 8.

In a step 810, the controller 633 initiates the process 800. The controller 633 may initiate the process 800 once when the aftertreatment system 500 or 600 is first deployed, before deploying the aftertreatment system 500 or 600, or when the pump 620, the doser 660A or the doser 660B is installed. When the controller 633 initiates the process 800, variables such as Dosing Cmd, Idle Learn, Dosing Learn can be set to initial values (e.g., ‘0’). The controller 633 may store the variables or indicators Dosing Cmd, Idle Learn, Dosing Learn in the memory of the controller 633. Dosing Cmd may be an indicator that indicates whether the doser 660A or the doser 660B is dosing reductant into one or more decomposition chambers (or mixers 570A, 570B). Idle Learn may be an indicator that indicates whether the first speed Ω₁ of the pump 620 in the idle mode is determined or not. Dosing Learn may be an indicator that indicates whether the second speed Ω₂ of the pump 620 in the first dosing mode and the third speed Ω₃ of the pump 620 in the second dosing mode is determined or not.

In a step 815, the controller 633 determines whether Dosing Cmd has a value of ‘0’. Dosing Cmd having the value ‘0’ may indicate that the aftertreatment system 500 or 600 operates in the idle mode, whereas Dosing Cmd having a value different from ‘0’ may indicate that the aftertreatment system 500 or 600 operates in the first dosing mode or the second dosing mode. In response to Dosing Cmd having the value different from ‘0’, the controller 633 may proceed to a step 835. In response to Dosing Cmd having the value ‘0’, the controller 633 may wait for the pump speed to stabilize. In a step 820, when the pump speed stabilizes in the idle mode to achieve the target pressure P_{target}, the controller 633 may determine the pump speed Ω₁ of the pump 620. In a step 825, in response to determining the pump speed Ω₁ of the pump 620, the controller 630 may set Idle Learn to have a value ‘1’. Idle Learn having the value ‘0’ may indicate that the pump speed Ω₁ of the pump 620 operating in the idle mode is not determined yet, whereas Idle Learn having the value ‘1’ may indicate that the pump speed Ω₁ of the pump 620 operating in the idle mode is determined.

In a step 830, after setting the Idle Learn to have the value ‘1’ in the step 825, the controller 633 may determine whether Dosing Learn has a value of ‘0’. Dosing Learn having the value ‘0’ may indicate that the pump speed Ω₂ of the pump 620 operating in the first dosing mode and the pump speed Ω₃ of the pump 620 operating in the second dosing mode are not determined yet, whereas Dosing Learn having the value ‘1’ may indicate that the pump speed Ω₂ of the pump 620 operating in the first dosing mode and the pump speed Ω₃ of the pump 620 operating in the second dosing mode are determined. In a step 855, in response to determining that Dosing Learn does not have the value ‘0’ (or has the value ‘1’), the controller 633 may determine the offset pressure value ΔP, the effective orifice area Aᵢₙⱼ₁ of the injector 614A, the effective orifice area Aᵢₙⱼ₂ of the injector 614B and the displacement amount D, according to Eq. (16)-(19). According to the offset pressure value ΔP, the effective orifice area Aᵢₙⱼ₁ of the injector 614A, the effective orifice area Aᵢₙⱼ₂ of the injector 614B, and the displacement amount D, the controller 633 may update the pump flow model or Eq. (12) to improve accuracy of the aftertreatment system 500 or 600. Moreover, the controller 633 may generate electrical signals or commands to operate the pump 620 and the dosers 660A, 660B according to the updated pump flow model.

In the step 835, in response to determining that Dosing Learn has the value ‘0’, the controller 633 may determine whether Dosing Cmd is larger than a threshold value. The threshold value may be predetermined or adjusted. In one aspect, Dosing Cmd having a value larger than the threshold value may indicate that sufficient reductant is provided to the one or more decomposition chambers (e.g., or mixers 570A, 570B) to measure the pump speed Ω₂ in the first dosing mode and the pump speed Ω₃ in the second dosing mode, whereas Dosing Cmd having a value less than or equal to the threshold value may indicate that insufficient reductant is provided to the one or more decomposition chambers (e.g., or mixers 570A, 570B) to measure the pump speed Ω₂ in the first dosing mode and the pump speed Ω₃ in the second dosing mode. As such, in response to determining that Dosing Cmd has a value less than or equal to the threshold value, the controller 633 may proceed to the step 815. In response to determining that Dosing Cmd has a value larger than the threshold value, the controller 633 may configure the dosers 660A, 660B to operate in the first dosing mode and wait for the pump speed to stabilize. In a step 840, when the pump speed stabilizes in the first dosing mode to achieve the target pressure P_{target}, the controller 633 may determine the pump speed Ω₂ of the pump 620. In response to determining the pump speed Ω₂, the controller 633 may configure the dosers 660A, 660B to operate in the second dosing mode. In a step 842, when the pump speed stabilizes in the second dosing mode to achieve the target pressure P_{target} in the second dosing mode, the controller 633 may determine the pump speed Ω₃ of the pump 620. In a step 845, in response to determining the pump speeds Ω₂, Ω₃, the controller 630 may set Dosing Learn to have a value ‘1’.

In a step 850, after setting the Dosing Learn to have the value ‘1’ in the step 845, the controller 633 may determine whether Idle Learn has a value of ‘1’. In response to determining that Idle Learn does not have the value ‘1’, the controller 633 may proceed to the step 815. In the step 855, in response to determining that Idle Learn has the value ‘1’, the controller 633 may determine the offset pressure value ΔP, the effective orifice area Aᵢₙⱼ₁ of the injector 614A, the effective orifice area Aᵢₙⱼ₂ of the injector 614B and the displacement amount D, according to Eq. (16)-(19). According to the offset pressure value ΔP, the effective orifice area Aᵢₙⱼ₁ of the injector 614A, the effective orifice area Aᵢₙⱼ₂ of the injector 614B and the displacement amount D, the controller 633 may update the pump flow model or Eq. (12) to improve accuracy of the aftertreatment system 500 or 600. Moreover, the controller 633 may generate electrical signals or commands to operate the pump 620 and the dosers 660A, 660B according to the updated pump flow model.

### X. Construction of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to,” “fluidly configured to communicate with,” and the like, as used herein, mean the two components or objects have a pathway formed between the two components or objects in which a fluid, such as air, liquid reductant, gaseous reductant, aqueous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language “a portion” is used, the item can include a portion and/or the entire item unless specifically stated to the contrary.

What is claimed is:

1. A controller for use in an aftertreatment system that comprises a doser configured to dose reductant into a decomposition chamber and a pump configured to supply the reductant to the doser, the controller configured to be operatively coupled to the doser and the pump and programmed to:
cause the pump and the doser to operate in an idle mode in which the pump supplies the reductant from a reductant tank to the doser at steady state, the doser does not dose the reductant, and the reductant supplied to the doser by the pump is recirculated to the reductant tank;
while the pump and the doser operate in the idle mode, determine a first speed of the pump required to achieve a predetermined target pressure;
cause the pump and the doser to operate in a dosing mode in which the pump supplies the reductant to the doser, and the doser doses the reductant into the decomposition chamber at steady state;
while the pump and the doser operate in the dosing mode, determine a second speed of the pump required to achieve the predetermined target pressure; and
generate a command to configure the pump and the doser, based on the first speed and the second speed.

2. The controller of claim 1,
wherein the doser comprises a pressure sensor configured to provide a pressure measurement value that has been adjusted by an offset pressure value, and
wherein the controller is programmed to:
determine the offset pressure value, based on the first speed and the second speed, and
generate the command based on the determined offset pressure value.

3. The controller of claim 2, wherein the controller is programmed to:
determine an effective orifice area of the doser, based on the determined offset pressure value, and
generate the command to configure the pump and the doser, based on the determined effective orifice area.

4. The controller of claim 3, wherein the controller is programmed to:
determine a displacement amount of the pump, based on the determined offset pressure value, and
generate the command to configure the pump and the doser, based on the determined displacement amount.

5. The controller of claim 4, wherein the controller is programmed to:
update a pump flow model of the aftertreatment system, based on the determined displacement amount and the determined effective orifice area, and
generate the command to configure the pump and the doser, based on the updated pump flow model.

6. The controller of claim 3, wherein the controller is programmed to:
determine a duty cycle of the doser, based on the effective orifice area, and
generate the command to configure the pump and the doser, based on the determined duty cycle of the doser.

7. The controller of claim 1, wherein the controller is programmed to:
determine an effective orifice area of the doser, based on the first speed and the second speed,
determine a duty cycle of the doser, based on the effective orifice area, and
generate the command to configure the pump and the doser, based on the determined duty cycle of the doser.

8. A controller for use in an aftertreatment system that comprises a first doser configured to dose reductant into a first decomposition chamber, a second doser configured to dose the reductant into a second decomposition chamber, and a pump configured to supply the reductant to the first doser, the first doser coupled between the pump and the second doser, the controller configured to be operatively coupled to the first doser, the second doser, and the pump and programmed to:
cause the pump, the first doser and the second doser to operate in an idle mode in which the pump supplies the reductant from a reductant tank to the first doser at steady state, the first doser and the second doser do not dose the reductant, and the reductant supplied to the first doser and the second doser by the pump is recirculated to the reductant tank;
while the pump, the first doser and the second doser operate in the idle mode, determine a first speed of the pump required to achieve a predetermined target pressure;
cause the pump, the first doser and the second doser to operate in a first dosing mode in which the pump supplies the reductant to the first doser, the first doser doses the reductant into the first decomposition chamber at steady state, and the second doser does not dose the reductant;
while the pump, the first doser, and the second doser operate in the first dosing mode, determine a second speed of the pump required to achieve the predetermined target pressure;
cause the pump, the first doser and the second doser to operate in a second dosing mode in which the pump supplies the reductant to the first doser, the second doser doses the reductant into the second decomposition chamber at steady state, and the first doser does not dose the reductant;
while the pump, the first doser, and the second doser operate in the second dosing mode, determine a third speed of the pump required to achieve the predetermined target pressure; and
generate a command to configure the pump, the first doser and the second doser, based on the first speed, the second speed, and the third speed.

9. The controller of claim 8, wherein the pump is configured to supply the reductant to the second doser through the first doser.

10. The controller of claim 8,
wherein the second doser comprises a pressure sensor configured to provide a pressure measurement value that has been adjusted by an offset pressure value, and
wherein the controller is programmed to:
determine the offset pressure value, based on the first speed and the third speed, and
generate the command to configure the pump, the first doser and the second doser, based on the determined offset pressure value.

11. The controller of claim 10, wherein the controller is programmed to:
determine a first effective orifice area of the second doser, based on the determined offset pressure value, and
generate the command to configure the pump, the first doser and the second doser, based on the determined first effective orifice area.

12. The controller of claim 11, wherein the controller is programmed to:
determine a displacement amount of the pump, based on the determined offset pressure value, and
generate the command to configure the pump, the first doser and the second doser, based on the determined displacement amount.

13. The controller of claim 12, wherein the controller is programmed to:
determine a second effective orifice area of the first doser, based on the determined displacement amount of the pump, the first speed, and the second speed, and
generate the command to configure the pump, the first doser and the second doser, based on the determined second effective orifice area.

14. The controller of claim 13, wherein the controller is configured to:
update a pump flow model of the aftertreatment system, based on the determined displacement amount, the determined first effective orifice area, and the determined second effective orifice area, and
generate the command to configure the pump, the first doser and the second doser, based on the updated pump flow model.

15. The controller of claim 13, wherein the controller is programmed to:
determine a dosing adjustment factor of the first doser, based on the first effective orifice area and the second effective orifice area, and
generate the command to configure the first doser, according to the dosing adjustment factor.

16. The controller of claim 8, wherein the controller is programmed to:
determine a displacement amount of the pump, based on the first speed,
determine a first effective orifice area, based on the displacement amount of the pump, the first speed, and the second speed,
determine a second effective orifice area, based on the displacement amount of the pump, the first speed, and the third speed,
determine a first dosing adjustment factor of the first doser, based on the first effective orifice area,
determine a second dosing adjustment factor of the second doser, based on the second effective orifice area, and
generate the command to configure the first doser and the second doser, according to the first dosing adjustment factor and the second dosing adjustment factor.

17. A method for use in an aftertreatment system that comprises a doser configured to dose reductant into a decomposition chamber and a pump configured to supply the reductant to the doser, the method comprising:
causing, by a processor, the pump and the doser to operate in an idle mode in which the pump supplies the reductant from a reductant tank to the doser at steady state, the doser does not dose the reductant, and the reductant supplied to the doser by the pump is recirculated to the reductant tank;
determining, by the processor, a first speed of the pump required to achieve a predetermined target pressure, while the pump and the doser operate in the idle mode;
causing, by the processor, the pump and the doser to operate in a dosing mode in which the pump supplies the reductant to the doser, and the doser doses the reductant into the decomposition chamber at steady state;
determining, by the processor, a second speed of the pump required to achieve the predetermined target pressure, while the pump and the doser operate in the dosing mode; and
generating, by the processor, a command to configure the pump and the doser, based on the first speed and the second speed.

18. The method of claim 17, wherein the doser comprises a pressure sensor configured to provide a pressure measurement value that has been adjusted by an offset pressure value, the method further comprising:
determining, by the processor, the offset pressure value, based on the first speed and the second speed; and
generating, by the processor, the command based on the determined offset pressure value.

19. The method of claim 18, further comprising:
determining, by the processor, an effective orifice area of the doser, based on the determined offset pressure value; and
determining, by the processor, a displacement amount of the pump, based on the determined offset pressure value.

20. The method of claim 19, further comprising:
updating, by the processor, a pump flow model of the aftertreatment system, based on the determined displacement amount and the determined effective orifice area; and
generating, by the processor, the command to configure the pump and the doser, based on the updated pump flow model.

21. The method of claim 19, further comprising:
determining, by the processor, a duty cycle of the doser, based on the effective orifice area; and
generating the command to configure the pump and the doser, based on the determined duty cycle of the doser.

22. The method of claim 17, further comprising:
determining, by the processor, an effective orifice area of the doser, based on the first speed and the second speed;
determining, by the processor, a duty cycle of the doser, based on the effective orifice area; and
generating, by the processor, the command to configure the pump and the doser, based on the determined duty cycle of the doser.

23. A method for use in an aftertreatment system that comprises a first doser configured to dose reductant into a first decomposition chamber, a second doser configured to dose the reductant into a second decomposition chamber, and a pump configured to supply the reductant to the first doser, the first doser coupled between the pump and the second doser, the method comprising:
causing, by a processor, the first doser and the second doser to operate in an idle mode in which the pump supplies the reductant from a reductant tank to the first doser at steady state, the first doser and the second doser do not dose the reductant, and the reductant supplied to the first doser and the second doser by the pump is recirculated to the reductant tank;
determining, by the processor, a first speed of the pump required to achieve a predetermined target pressure, while the pump, the first doser and the second doser operate in the idle mode;
causing, by the processor, the pump, the first doser and the second doser to operate in a first dosing mode in which the pump supplies the reductant to the first doser, the first doser doses the reductant into the first decomposition chamber at steady state, and the second doser does not dose the reductant;
determining, by the processor, a second speed of the pump required to achieve the predetermined target pressure, while the pump, the first doser, and the second doser operate in the first dosing mode;
causing, by the processor, the pump, the first doser and the second doser to operate in a second dosing mode in which the pump supplies the reductant to the first doser, the second doser doses the reductant into the second decomposition chamber at steady state, and the first doser does not dose the reductant;
determining, by the processor, a third speed of the pump required to achieve the predetermined target pressure, while the pump, the first doser, and the second doser operate in the second dosing mode; and
generating, by the processor, a command to configure the pump, the first doser and the second doser, based on the first speed, the second speed, and the third speed.

24. The method of claim 23, wherein the second doser comprises a pressure sensor configured to provide a pressure measurement value that has been adjusted by an offset pressure value, the method further comprising:
determining, by the processor, the offset pressure value, based on the first speed and the third speed; and
generating, by the processor, the command to configure the pump, the first doser and the second doser, based on the determined offset pressure value.

25. The method of claim 24, further comprising:
determining, by the processor, a first effective orifice area of the second doser, based on the determined offset pressure value;
determining, by the processor, a displacement amount of the pump, based on the determined offset pressure value; and
determining, by the processor, a second effective orifice area of the first doser, based on the determined displacement amount of the pump, the first speed, and the second speed.

26. The method of claim 25, further comprising:
updating, by the processor, a pump flow model of the aftertreatment system, based on the determined displacement amount, the determined first effective orifice area, and the determined second effective orifice area; and
generating, by the processor, the command to configure the pump, the first doser and the second doser, based on the updated pump flow model.

27. The method of claim 25, further comprising:
determining, by the processor, a dosing adjustment factor of the first doser, based on the first effective orifice area and the second effective orifice area; and
generating, by the processor, the command to configure the first doser, according to the dosing adjustment factor.

28. The method of claim 23, further comprising:
determining, by the processor, a displacement amount of the pump, based on the first speed;
determining, by the processor, a first effective orifice area, based on the displacement amount of the pump, the first speed, and the second speed;
determining, by the processor, a second effective orifice area, based on the displacement amount of the pump, the first speed, and the third speed;
determining, by the processor, a first dosing adjustment factor of the first doser, based on the first effective orifice area;
determining, by the processor, a second dosing adjustment factor of the second doser, based on the second effective orifice area; and
generating, by the processor, the command to configure the first doser and the second doser, according to the first dosing adjustment factor and the second dosing adjustment factor.
